(19) United States
(12) Patent Application Publication
(10) Pub. No.: US 2018/0339345 A1
(43) Pub. Date: Nov. 29, 2018

(54) METHODS FOR PRODUCING MULTIFACETED NANOPARTICLES USING POLYMER BRUSH ARCHITECTURES

(71) Applicants: Nitin CHOPRA, Sugar Land, TX (US); Saad ALHUSSAIN, Sugar Land, TX (US); Ihab N. ODEH, Sugar Land, TX (US); SABIC Global Technologies B.V., Bergen op Zoom (NL)

(72) Inventors: Nitin Chopra, Sugar Land, TX (US); Saad Alhussain, Sugar Land, TX (US); Ihab N. Odeh, Sugar Land, TX (US)

(21) Appl. No.: 15/778,104

(22) PCT Filed: Nov. 28, 2016
(86) PCT No.: PCT/IB2016/057163

§ 371 Date: May 22, 2018

Related U.S. Application Data
(60) Provisional application No. 62/262,525, filed on Dec. 3, 2015.
(60) Provisional application No. 62/425,294, filed on Nov. 22, 2016.

(51) Int. Cl. B22F 9/24; C01B 13/08; B22F 1/00; C04B 35/628

(52) U.S. Cl. CPC B22F 9/24; C01B 13/08; B22F 1/0018; C04B 2235/5454; C04B 2235/3217; C04B 2235/425; C04B 2235/5292; C04B 35/62842

(57) ABSTRACT

Methods for producing multifaceted nanoparticles and uses thereof are disclosed. One method for producing multifaceted nanoparticles can include obtaining a template that includes a substrate and a polymer brush having a plurality of polymers each attached by a first end to the substrate and each having a free opposing second end located opposite the first end; contacting the polymer brush with a solution that includes a nanoparticle precursor material; and forming, from the precursor material and the functional groups located on the second end of the plurality of polymers, multifaceted nanoparticles. The second ends of the polymer chains are functionalized with functional groups that have an affinity for the facets of the multifaceted nanoparticles.

### CROSS REFERENCE TO RELATED APPLICATIONS

This application claims the benefit of priority of U.S. Provisional Patent Application No. 62/262,525 filed Dec. 3, 2015, and U.S. Provisional Patent Application No. 62/425,294 filed Nov. 22, 2016. The entire contents of each of the above-referenced disclosures are specifically incorporated herein by reference without disclaimer.

### BACKGROUND OF THE INVENTION

### A. Field of the Invention

The invention generally concerns methods for producing multifaceted nanoparticles. In particular, the invention concerns forming multifaceted nanoparticles from functionalized polymer brushes and nanoparticle precursor materials.

### B. Description of Related Art

There are currently several processes available for producing inorganic nanostructures, examples of which include electroless plating, sol-gel, solution precipitation/deposition, and polymer polyelectrolyte surfactant assisted methods. A significant challenge for producing nanoparticles is the ability to control the growth and/or shape of the nanoparticle. Ideally, single-crystalline surfaces that are clean and well characterized are desired. One of the complications has been due to the electronic interactions of the nanoparticles and/or the conditions under which the nanoparticles are grown. For example, obstacles in the area of shape-controlled nanocatalysis from colloidal methods include compatible surface chemistry and shape retention. The shaped colloidal particles, which, by nature of their synthesis, are protected by a layer of organic material and removal of these stabilizing agents may be required to create accessible active sites, during which significant morphological change can occur via surface reconstruction, particle ripening, melting, or oxidation. For instance, removal of adsorbed capping molecules from a colloidal synthesis of tetrahedral, cubical and truncated cube can cause rounding of the corners and edges and/or complete transformation into sphere-like droplets (See, for example, Tao, et al., “Shape Control of Colloidal Metal Nanocrystals” Review, Small, 2008, Vol. 4, 310-325).

Various attempts to control the aggregation of nanoparticles, and/or to control the shape and size of nanoparticles have been disclosed. Oren et al., “Organization of Nanoparticles in Polymer Brushes”, J. American Chemical Soc. 2009, 131, pp. 1670, describes infiltrating gold nanoparticles in block copolymer brushes by immersing a polymer brush into a solution of polystyrene covered gold nanoparticles to form a film having separated gold nanoparticles. Zhu et al., “Spherical polyelectrolyte brushes as a nanoreactor for synthesis of ultrafine magnetic particles”, Nanotechnology, 2012, 23, 265601, describes the addition of ferric chloride to a spherical polyelectrolyte brushes latex to produce ultrafine magnetic nanoparticles of different sizes. Gao et al., “Plasmonic nanocomposites: polymer-guided strategies for assembling metal nanoparticles”, Nanoscale, 2013, 5, 5677, describes surface modification of nanoparticles with polymer grafts (e.g., polymer brushes) to control size and shape of the nanoparticles. Sugnaux et al., “Polymer Brush Guided Formation of Conformal, Plasmonic Nanoparticle-Based Electrodes for Microwire Solar Cells”, Advanced Functional Materials, 2015, 3958-3965, describes making silver wires by using a polymer brush as template for growing nanowires of desired thickness.

While various attempts have been made to grow faceted nanoparticles, these methods suffer from nanostructure aggregation and/or lack of control of the size and/or shape of the nanoparticle or of the facets on the nanoparticle surface.

### SUMMARY OF THE INVENTION

A discovery has been made that addresses the problems associated with growing faceted nanoparticles. The discovery is premised on the idea of being able to produce nanoparticles with tuned facets, shapes, and sizes by using shape/facet-selective and multifunctional polymer brush architectures as physical and molecular scale templates. The choice of the polymer functional group can allow tunability of the nanoparticle size, shape and/or facets. Without wishing to be bound by theory, it is believed that the polymer end functionality, hydrophobicity/hydrophilicity, amphiphilicity/lipophillicity, and/or geometry, and/or physical dimensions of polymer brush architectures can be selective to a specific facet of a growing nanoparticle (e.g., transition metal, bi-metallic, alloyed, or noble metal systems), which allows for fine tuning of growing facets and size of the nanoparticle. Further, the polymer brush architecture and physical dimensions can allow for production of nanoparticles with one kind of facet and size and enable controlled bi-modal distributions of such nanoparticles. In addition, the brush architectures of the present invention can be used as “nano-reactors” for confined space growth of nanoparticles/nanostructures and/or facilitation of a chemical reaction. Polymer brush architectures in the form of nano-reactors for confined space nanoparticle growth can mitigate or eliminate nanoparticle aggregation and surpass challenges associated with thermodynamic and kinetic control parameters common in free-solution growth of nanoparticles. Still further, the produced multifaceted nanoparticle/polymer brush composite material can be incorporated into a variety of applications, devices, drug delivery systems, etc. Alternatively, the produced multifaceted nanoparticles can be released from the polymer brushes, thereby resulting in free or isolated multifaceted nanoparticles, which can also be incorporated into a variety of applications, devices, drug delivery systems, etc.

In one aspect of the present invention, methods for producing multifaceted nanoparticles are disclosed. A method can include (a) obtaining a template that includes a substrate and a polymer brush having a plurality of polymers each attached by a first end to the substrate and each having a free opposing second end located opposite the first end, (b) contacting the polymer brush with a solution comprising a nanoparticle precursor material, and (c) forming, from the precursor material and the functional groups located on the second end of the plurality of polymers, multifaceted nanoparticles. The substrate can be an organic substrate surface or an inorganic substrate surface. In some instances, the substrate can be a polymer (e.g., a polymeric backbone/substrate for the polymer brushes). The second end of the polymer can be functionalized with a functional group that has an affinity for the facets of the multifaceted nanoparticles. These functional groups can control, in part, the size and/or shape of the facets. The shape of the facets can be substantially uniform. In some aspects, the multifaceted nanoparticles have a spherical shape with an average diameter of 100 nm or less, preferably 1 nm to 20 nm or more preferably 1 nm to 5 nm. In other aspects, the multifaceted nanoparticles can have a platelet shape, an elongated rod shape, hexagonal shape, octagonal shape, heptagonal shape, square shape, triangular shape, rectangular shape, trapezoid shape, and oval shape or combinations thereof. The facets can be 3 to 8 sided facets or 2 to 8, preferably 2 to 6 facets. The method can also include (a) obtaining a second template having a second substrate and a second polymer brush having a plurality of polymers each attached by a third end to the second substrate and each having a free opposing fourth end located opposite the third end, (b) positioning the second ends of the polymers from the polymer brush proximate to the fourth ends of the polymers from the second polymer brush, (c) contacting the polymer brush and the second polymer brush with the solution, and (d) forming the multifaceted nanoparticles between the second and fourth ends of the plurality of polymers. The fourth end of the polymer can be functionalized with a functional group that has an affinity for the facets of the multifaceted nanoparticles. In a particular aspect, the second template can have a substantially the same substrate, polymer brush, and/or functional groups as the template in step (a). The surface of the substrate that has the first and/or third ends of the polymers attached thereto can be any shape or size, (e.g., substantially planar, concave, convex, spherical) or be a hollow shell where the first ends of the polymers are attached to the inside surface of the hollow shell or the outside surface of the hollow shell or both the inside and outside surfaces of the hollow shell. In certain instances, the substrate can be flexible. The substrate can be carbon nanotube, a nanorod, a quantum dot, a hollow shell, a nanostructure, a polymer chain, a microstructure, a microtube, a microwire, a microrod, a corrugated surface, a roughened surface, a curved surface or a film, and a nanoarchitectured surface. In preferred embodiments, the substrate comprises a silicon wafer, graphene oxide flakes, alumina nanoparticles, or combinations thereof. Polymers attached to the substrate can include polystyrene-block-poly(2-vinyl pyridine), poly-norborene-poly-isoprene, poly((2-(methacryloyloxy)ethyl)-trimethylammonium chloride) (PMETAC), poly(2-hydroxyethyl methacrylate) (PHEMA), alkylthiols, phenylsulfonates, alkylphosphonates, alkylamines, and fluoroalkyls, norborene-polystyrene based, poly(N,N-dimethylaminoethyl methacrylate), poly-(styrene-b-methyl methacrylate) (PS-b-PMMA), poly(styrene-b-isoprene) (PS-b-PI), poly(styrene-b-butadiene) (PS-b-PB), poly(2-vinylpyridine-b-styrene) (P2VP-b-PS), poly(4-vinylpyridine-b-styrene) (P4VP-b-PS), poly(ethylene) oxide (PEO), poly(ethylene) glycol, Poly (N, N-dimethylacrylamide)(PDMA), polyethylene terephthalate (PET), polypropylene (PP), polyethylene, polyphenyl oxide, polybutylene Terephthalate, poly(1,4-cyclohexylidene cyclohexane-1,4-dicarboxylate (PCCD), PCTG, poly vinyl chloride (PVC), poly(methyl metharylate) (PMMA), Nylon, polysulfones, polyetherketones, thermoset polymers such as epoxy, thermoresponsive polymers such as poly(N-isopropyl acrylamide).or any combination thereof, or blend thereof. These polymers can include an amine, phosphorous, a thiol group, an alkyl, a halide, hydrogen sulfite, phosphate, carboxylic acid, a polyol, an alkyl sulfate, or combinations thereof functional group. The precursor nanoparticle material can include a metal salt and the produced multifaceted nanoparticle can include a metal or oxide thereof and/or be bimetallic or trimetallic particles. Metals or metal oxides thereof can include noble metals (e.g., silver (Ag), palladium (Pd), platinum (Pt), gold (Au), rhodium (Rh), ruthenium (Ru), rhenium (Re), or iridium (Ir), Osmium (Os) or any combinations or oxides or alloys thereof) and/or transition metals (e.g., copper (Cu), iron (Fe), nickel (Ni), zinc (Zn), manganese (Mn), chromium (Cr), molybdenum (Mo), tungsten (W), or tin (Sn), or any combinations or oxides or alloys thereof). Metal oxides can include silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof. In some aspects, the produced multifaceted nanoparticles can be assembled. Multifaceted nanoparticles and/or assembled multifaceted nanoparticles can be isolated, stored, packaged, and/or used in many applications.

In another aspect of the present invention, multifaceted nanoparticle composite materials are disclosed. One multifaceted nanoparticle composite material can include (a) a substrate, (b) a polymer brush having a plurality of polymers each attached by a first end to the substrate and each having a free opposing second end located opposite the first end, and (c) a plurality of multifaceted nanoparticles that have affinity for the functional groups of the plurality of polymers. The second ends can be functionalized with a functional group. The size and/or shape of the facets can be substantially uniform. In some aspects, the multifaceted nanoparticles have a spherical shape with an average diameter of 100 nm or less, preferably 1 nm to 20 nm or more preferably 1 nm to 5 nm. In other aspects, the multifaceted nanoparticles can have a platelet shape, an elongated rod shape, hexagonal shape, octagonal shape, heptagonal shape, square shape, triangular shape, rectangular shape, trapezoid shape, and oval shape or combinations thereof. The facets can be 3 to 8 sided facets or 2 to 8, preferably 2 to 6 facets. The multifaceted nanoparticle composite material can also include (d) a second substrate and (e) a second polymer brush having a plurality of polymers each attached by a third end to the second substrate and each having a free opposing fourth end located opposite the third end. The fourth end of the polymer can be functionalized with a functional group and the second and fourth ends have an affinity for the facets of the multifaceted nanoparticles. In a particular aspect, the second substrate, polymer brush, can be substantially the same as the first substrate and the first polymer brush. The surface of the substrate that has the first and/or third ends of the polymers attached thereto can be any shape, size or texture, (e.g., substantially planar, concave, convex, spherical, roughened, corrugated, nanoarchitectured or the like.), be a hollow shell where the first ends of the polymers are attached to the inside surface of the hollow shell or the outside surface of the hollow shell or both the inside and outside surfaces of the hollow shell. In certain instances, the substrate can be flexible. The substrate can be carbon nanotube, a nanorod, a quantum dot, a hollow shell, a nanostructure, a polymer chain, a microstructure, a microtube, a microwire, a microrod, a film, and combinations thereof. Polymers attached to the substrate can include the polymers describe above. These polymers can include an amine, phosphorous, a thiol group, an alkyl, a halide, hydrogen sulfite, phosphate, carboxylic acid, a polyol, an alkyl sulfate, or combinations thereof functional group. The produced multifaceted nanoparticle can include a metal or oxide thereof and/or be bimetallic or trimetallic particles described above. In some aspects, the produced multifaceted nanoparticles can be assembled. Multifaceted nanoparticles and/or assembled multifaceted nanoparticles can be isolated, stored, packaged, and/or used in many applications.

Articles of manufacture that include the multifaceted nanoparticle composite material and/or the multifaceted nanoparticles described herein are disclosed. In certain aspects, after the multifaceted nanoparticles have been produced, they can then be released from the polymer brushes. In certain aspects, and after their release from the polymer brushes, the multifaceted nanoparticles can be freely suspended in a composition. Even further, the produced multi-faceted nanoparticles, whether released from the polymer brushes or not, can be incorporated into all types of articles of manufacture. Non-limiting examples of such articles of manufacture can include optical films, plasmonic substrates, zero Possion's ratio materials, responsive polymer materials, flexible nano-devices, catalytic architectures, controlled release media, separation media, membranes, energy storage applications or devices, sensor devices, medicinal delivery systems, or chemical delivery systems.

In the context of the present invention there are 49 embodiments described. Embodiment 1 is a method for producing multifaceted nanoparticles, the method comprising: (a) obtaining a template comprising a substrate and a polymer brush having a plurality of polymers each attached by a first end to the substrate and each having a free opposing second end located opposite the first end, wherein the second end is functionalized with a functional group; (b) contacting the polymer brush with a solution comprising a nanoparticle precursor material; and (c) forming, from the precursor material and the functional groups located on the second end of the plurality of polymers, multifaceted nanoparticles wherein the functional groups have affinity for the facets of the multifaceted nanoparticles. Embodiment 2 is the method of embodiment 1, wherein the size and/or shape of the facets are controlled, in part, by the functional groups. Embodiment 3 is the method of embodiment 2, wherein the size and/or shape of the facets are substantially uniform. Embodiment 4 is the method of any one of embodiments 1 to 3, wherein the multifaceted nanoparticles have a spherical shape with an average diameter of 100 nm or less, preferably 1 nm to 20 nm, or more preferably 1 nm to 5 nm. Embodiment 5 is the method of any one of embodiments 1 to 3, wherein the multifaceted nanoparticle has a platelet shape, an elongated rod shape, hexagonal shape, octagonal shape, heptagonal shape, square shape, triangular shape, rectangular shape, trapezoid shape, and oval shape. Embodiment 6 is the method of any one of embodiments 1 to 5, wherein the facets are 3 to 8 sided facets. Embodiment 7 is the method of any one of embodiments 1 to 6, wherein the multifaceted nanoparticles have 2 to 8 facets, preferably 2 to 6 facets. Embodiment 8 is the method of any one of embodiments 1 to 7, wherein the surface of the substrate that has the first ends of the polymers attached thereto is substantially planar. Embodiment 9 is the method of any one of embodiments 1 to 7, wherein the surface of the substrate that has the first ends of the polymers attached thereto is substantially concave or convex. Embodiment 10 is the method of any one of embodiments 1 to 7, wherein the substrate has a substantially spherical shape and the first ends of the polymers are attached to the outer surface of the substrate. Embodiment 11 is the method of any one of embodiments 1 to 7, wherein the substrate is a hollow shell and the first ends of the polymers are attached to the inside surface of the hollow shell or the outside surface of the hollow shell or both the inside and outside surfaces of the hollow shell. Embodiment 12 is the method of any one of embodiments 1 to 11, wherein the substrate is flexible. Embodiment 13 is the method of any one of embodiments 1 to 12, further comprising: obtaining a second template having a second substrate and a second polymer brush having a plurality of polymers each attached by a third end to the second substrate and each having a free opposing fourth end located opposite the third end, wherein the fourth end is functionalized with a functional group; positioning the second ends of the polymers from the polymer brush proximate to the fourth ends of the polymers from the second polymer brush; contacting the polymer brush and the second polymer brush with the solution; and forming the multifaceted nanoparticles between the second and fourth ends of the plurality of polymers wherein the functional groups on the second and fourth ends of the polymers have affinity for the facets. Embodiment 14 is the method of embodiment 13, wherein the second template has substantially the same substrate, polymer brush, and/or functional groups as the template in step (a). Embodiment 15 is the method of any one of embodiments 1 to 14, wherein the substrate is a carbon nanotube, a nanorod, a quantum dot, a hollow shell, a nanostructure, a polymer chain, a microstructure, a microtube, a microwire, a microrod, a corrugated surface, a roughened surface, a curved surface or a film, and a nanoarchitectured surface. Embodiment 16 is the method of any one of embodiments 1 to 15, wherein the plurality of polymers include polystyrene-block-poly(2-vinyl pyridine), poly-norborene-poly-isoprene, poly((2-(methacryloyloxy)ethyl)-trimethylammonium chloride) (PMETAC), poly(2-hydroxyethyl methacrylate) (PHEMA), alkylthiols, phenylsulfonates, alkylphosphonates, alkylamines, and fluoroalkyls, norborene-polystyrene based, poly(N,N-dimethylaminoethyl methacrylate), poly-(styrene-b-methyl methacrylate) (PS-b-PMMA), poly(styrene-b-isoprene) (PS-b-PI), poly(styrene-b-butadiene) (PS-b-PB), poly(2-vinylpyridine-b-styrene) (P2VP-b-PS), poly(4-vinylpyridine-b-styrene) (P4VP-b-PS), poly(ethylene) oxide (PEO), poly(ethylene) glycol, Poly (N, N-dimethylacrylamide)(PDMA), polyethylene terephthalate (PET), polypropylene (PP), polyethylene, polyphenyl oxide, polybutylene Terephthalate, poly(1,4-cyclohexylidene cyclohexane-1,4-dicarboxylate (PCCD), PCTG, poly vinyl chloride (PVC), poly(methyl metharylate) (PMMA), Nylon, polysulfones, polyetherketones, thermoset polymers such as epoxy, or any combination thereof, or blend thereof. Embodiment 17 is the method of any one of embodiments 1 to 15, wherein the plurality of polymers comprises a thermoresponsive polymer, preferably poly(N-isopropyl acrylamide). Embodiment 18 is the method of any one of embodiments 1 to 17, wherein the functional group is an amine, phosphorous, a thiol group, an alkyl, a halide, hydrogen sulfite, phosphate, carboxylic acid, a polyol, an alkyl sulfate, or combinations thereof. Embodiment 19 is the method of any one of embodiments 1 to 17, wherein the precursor material includes a metal salt. Embodiment 20 is the method of embodiment 19, wherein the produced multifaceted nanoparticles comprise a metal or an oxide or alloy thereof. Embodiment 21 is the method of embodiment 20, wherein the metal is a noble metal selected from silver (Ag), palladium (Pd), platinum (Pt), gold (Au), rhodium (Rh), ruthenium (Ru), rhenium (Re), or iridium (Ir), or any combinations or oxides or alloys thereof. Embodiment 22 is the method of embodiment 21, wherein the metal is a transition metal selected from copper (Cu), iron (Fe), nickel (Ni), zinc (Zn), manganese (Mn), chromium (Cr), molybdenum (Mo), tungsten (W), osmium (Os), or tin (Sn), or any combinations or oxides or alloys thereof. Embodiment 23 is the method of embodiment 22, wherein the metal oxide is selected from silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof. Embodiment 24 is the method of any one of embodiments 19 to 23, wherein the multifaceted nanoparticles are bimetallic or trimetallic particles. Embodiment 25 is the method of any one of embodiments 1 to 24, further comprising isolating the produced multifaceted nanoparticles from the plurality of polymers. Embodiment 26 is the method of any one of embodiments 1 to 25, further comprising assembling the multifaceted nanoparticles. Embodiment 27 is a multifaceted nanoparticle prepared by the method of any one of embodiments 1 to 26.

Embodiment 28 is a multifaceted nanoparticle composite material comprising: (a) a substrate; (b) a polymer brush having a plurality of polymers each attached by a first end to the substrate and each having a free opposing second end located opposite the first end, wherein the second end is functionalized with a functional group; and (c) a plurality of multifaceted nanoparticles that have affinity for the functional groups of the plurality of polymers. Embodiment 29 is the multifaceted nanoparticle composite material of embodiment 28, wherein the size and/or shape of the facets are substantially uniform. Embodiment 30 is the multifaceted nanoparticle composite material of any one of embodiments 28 to 29, wherein the multifaceted nanoparticles have a spherical shape with an average diameter of 100 nm or less, preferably 1 nm to 20 nm, or more preferably 1 nm to 5 nm. Embodiment 31 is the multifaceted nanoparticle composite material of any one of embodiments 28 to 30, wherein the multifaceted nanoparticle has a platelet shape an elongated rod shape. Embodiment 32 is the multifaceted nanoparticle composite material of any one of embodiments 28 to 31, wherein the facets are 3 to 8 sided facets. Embodiment 33 is the multifaceted nanoparticle composite material of any one of embodiments 28 to 32, wherein the multifaceted nanoparticles have 2 to 8 facets, preferably 2 to 6 facets. Embodiment 34 is the multifaceted nanoparticle composite material of any one of embodiments 28 to 33, wherein the surface of the substrate that has the first ends of the polymers attached thereto is substantially planar. Embodiment 35 is the multifaceted nanoparticle composite material of any one of embodiments 28 to 34, wherein the surface of the substrate that has the first ends of the polymers attached thereto is substantially concave or convex. Embodiment 36 is the multifaceted nanoparticle composite material of any one of embodiments 28 to 35, wherein the substrate has a substantially spherical shape and the first ends of the polymers are attached to the outer surface of the substrate. Embodiment 37 is the multifaceted nanoparticle composite material of any one of embodiments 28 to 36, wherein the substrate is a hollow shell and the first end of the polymers are attached to the inside surface of the hollow shell or the outside surface of the hollow shell or both the inside and outside surfaces of the hollow shell. Embodiment 38 is the multifaceted nanoparticle composite material of any one of embodiments 28 to 37, wherein the substrate is flexible. Embodiment 39 is the multifaceted nanoparticle composite material of any one of embodiments 28 to 38, further comprising: (d) a second substrate; and (e) a second polymer brush having a plurality of polymers each attached by a third end to the second substrate and each having a free opposing fourth second end located opposite the third end, wherein the fourth end is functionalized with a functional group, wherein the functional groups on the second and fourth ends of the polymers have affinity for the facets. Embodiment 40 is the multifaceted nanoparticle composite material of embodiment 39, wherein the second substrate and the second polymer brush are substantially the same as the first substrate and the first polymer brush. Embodiment 41 is the multifaceted nanoparticle composite material of any one of embodiments 28 to 40, wherein the substrate is a carbon nanotube, a nanorod, a quantum dot, a hollow shell, a nanostructure, a polymer chain, a microstructure, a microtube, a microwire, a microrod, a corrugated surface, a roughened surface, a curved surface or a film, and a nanoarchitectured surface. Embodiment 42 is the multifaceted nanoparticle composite material of any one of embodiments 28 to 41, wherein the plurality of polymers comprise polystyrene-block-poly(2-vinyl pyridine), poly-norborene-poly-isoprene, poly((2-(methacryloyloxy)ethyl)-trimethylammonium chloride) (PMETAC), poly(2-hydroxyethyl methacrylate) (PHEMA), alkylthiols, phenylsulfonates, alkylphosphonates, alkylamines, and fluoroalkyls, norborene-polystyrene based, poly(N,N-dimethylaminoethyl methacrylate), poly-(styrene-b-methyl methacrylate) (PS-b-PMMA), poly(styrene-b-isoprene) (PS-b-PI), poly(styrene-b-butadiene) (PS-b-PB), poly(2-vinylpyridine-b-styrene) (P2VP-b-PS), poly(4-vinylpyridine-b-styrene) (P4VP-b-PS), poly(ethylene) oxide (PEO), poly(ethylene) glycol, Poly (N, N-dimethylacrylamide)(PDMA), polyethylene terephthalate (PET), polypropylene (PP), polyethylene, polyphenyl oxide, polybutylene Terephthalate, poly(1,4-cyclohexylidene cyclohexane-1,4-dicarboxylate (PCCD), PCTG, poly vinyl chloride (PVC), poly(methyl metharylate) (PMMA), Nylon, polysulfones, polyetherketones, thermoset polymers such as epoxy, or any combination thereof, or a thermoresponsive polymer poly(N-isopropyl acrylamide), or blend thereof. Embodiment 43 is the multifaceted nanoparticle composite material of any one of embodiments 28 to 42, wherein the multifaceted nanoparticles comprise a metal or an oxide or alloy thereof. Embodiment 44 is the multifaceted nanoparticle composite material of embodiment 43, wherein the metal is a noble metal selected from silver (Ag), palladium (Pd), platinum (Pt), gold (Au), rhodium (Rh), ruthenium (Ru), rhenium (Re), or iridium (Ir), or any combinations or oxides or alloys thereof. Embodiment 45 is the multifaceted nanoparticle composite material of embodiment 43, wherein the metal is a transition metal selected from copper (Cu), iron (Fe), nickel (Ni), zinc (Zn), manganese (Mn), chromium (Cr), molybdenum (Mo), tungsten (W), osmium (Os), or tin (Sn), or any combinations or oxides or alloys thereof. Embodiment 46 is the multifaceted nanoparticle composite material of embodiment 43, wherein the metal oxide is selected from silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof. Embodiment 47 is the multifaceted nanoparticle composite material of any one of embodiments 43 to 46, wherein the multifaceted nanoparticles are bimetallic or trimetallic particles. Embodiment 48 is an article of manufacture comprising the multifaceted nanoparticle composite material of any one of embodiments 28 to 47 or the multifaceted nanoparticles of embodiment 27. Embodiment 49 is the article of manufacture of embodiment 48, wherein the article of manufacture is an optical film, a plasmonic substrate, a zero Possion's ratio material, a responsive polymer material, a flexible nano-device, a catalytic architecture, a controlled release media, a separation media, a membrane, energy storage, sensor device, medicinal or chemical delivery system.

The following includes definitions of various terms and phrases used throughout this specification.

The term “affinity” is defined an attraction between two molecules that results in a stable association when the molecules are in close proximity to each other. Affinity can include electrostatic binding, Van der Waals attraction, covalent bonding, non-covalent bonding, ionic bonding, dipole-dipole interactions, or chelation.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising”, “including”, “containing”, or “having” in the claims, or the specification, may mean “one,” but it is also consistent with the meaning of “one or more”, “at least one”, and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods, materials or articles of manufacture of the present invention can “comprise,” “consist essentially of” or “consist of” particular ingredients, components, compositions, etc. disclosed throughout the specification. With respect to the transitional phase “consisting essentially of,” in one non-limiting aspect, a basic and novel characteristic of the methods of the present invention is the ability to produce and tune the size and/or shapes of multifaceted nanoparticles with polymer brushes that are functionalized with functional groups designed to produce a desired particle size and/or shape.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a schematic of an embodiment of a method for producing multifaceted nanoparticles from a single polymer brush.

FIG. 2 is a schematic of an embodiment of a method for producing multifaceted nanoparticles from at least two polymer brushes.

FIGS. 3A-3E depict illustrations of embodiments of various substrate configurations attached to the polymer brush architecture.

FIG. 4 depicts various illustrations of facets of multifaceted nanoparticles.

FIG. 5 is an scanning electron microscope (SEM) image of the PMMA brushes grafted on the silicon wafer.

FIG. 6 is a digital image of the PMMA brushes on the silicon wafer.

FIGS. 7A and 7B are SEM images of Pt nanoparticles between PMMA brushes grated on a silicon wafer at different 1 micron and 100 nm magnifications, respectively.

FIG. 8 is an SEM image of Pt nanoparticles between PHEMA brushes grated on a silicon wafer of the present invention.

FIGS. 9A and 9B are an SEM image of a gold nanoparticle between BiBBs functionalized a silicon wafer of the present invention. FIG. 9A is the SEM image of the non-brush region (left of dashed line) and brush-grafted region. FIG. 9B is the SEM image of the brush-grafted at higher magnification.

FIG. 10 is an SEM image of Pt nanoparticles between NIPAAm brushes grafted on the silicon wafer of the present invention.

FIG. 11 is a SEM image of PMMA brush grafted on graphene oxide flakes with Pt nanoparticles of the present invention.

FIG. 12 is a SEM image of PMMA brush grafted on alumina nanoparticles with Pt nanoparticles grown in a free solution of the present invention.

FIG. 13 is an transmission electron microscopy (TEM) image of an alumina nanoparticles coated with <2 nm Pt nanoparticles of the present invention.

FIGS. 14A, 14B, and 14C are TEM images of alumina nanoparticles grafted with PHEMA for Pt nanoparticle growth of the present invention. FIG. 14A shows a hollow shell formation with Pt nanoparticles at the outer edges. FIG. 14B shown Pt nanoparticles between two alumina nanoparticles.

FIG. 14C is a fast Fourier transform (FFT image) of alumina nanoparticles grafted with PHEMA for Pt nanoparticle growth of the present invention and shows symmetrical spots (bright spots in FIG. 14C) for Pt nanoparticles.

FIG. 15 is a TEM image of alumina nanoparticles grafted with PNIPAAM for Pt triangular shaped Pt nanoparticles of the present invention.

FIG. 16 is a SEM of alumina nanoparticles grafted with polyacrylic acid for Pt nanoparticle growth of the present invention.

FIG. 17 is a FFT image of a PAA grafted alumina nanoparticles decorated with Pt nanoparticles of the present invention.

FIG. 18 is a FFT image of alumina nanoparticles with Pt nanoparticles grown in the absence of PAA.

FIG. 19 is a FFT image of the Pt nanoparticles grown in a free solution without PAA.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

A discovery has been made that provides a solution for growing nanoparticles having desired facets, shapes and/or sizes. The discovery is premised on the ability to grow multifaceted nanoparticles using polymer brush architectures. Using polymer brush architectures can reduce or eliminate non-specific interactions between a solution environment and facet growth of nanoparticles (e.g., eliminate aggregations and rounding of particles due to heating of solutions), and control the thermodynamic parameters of nanoparticle growth. Specific facets can be realized by functionalizing the polymer brush architectures with specific functional groups shown in Table 1 and discussed below, thereby allowing the nanoparticle to be tuned for a particular application. In contrast to conventional methods, the multifaceted nanoparticles can be grown in polymer soluble and polymer insoluble media. The produced multifaceted nanoparticles can have a size less than 5 nm, thereby resulting in nanoparticles having a large surface area. The produced nanoparticles can be used in a variety of chemical applications, electrical applications, energy generation and storage applications, optical applications, and/or articles of manufacture. Further, the ability to use various shaped polymer brush architectures can allow tunability of facets and nanoparticle growth. For example, a brush on convex and concave side of curved support can allow for larger particle growth on the concave side and smaller particle growth on the convex side. In sum, the discovery allows for tuning of facets, stability, and multifunctionality of the produced multifaceted nanoparticles.

As further discussed below, the multifaceted nanoparticles are produced by using shape/facet-selective and multifunctional polymer brush architectures as physical and molecular scale templates. Without wishing to be bound by theory, it is believed that these physical templates (e.g., a nano-reactor) can provide confined spaces to control the size and assembly of produced nanoparticles. The end-functionality, hydrophobicity/hydrophilicity, amphiphilicity/lipophilicity, geometry, and/or physical dimensions of polymer brush architectures can be selective to a specific facet of a growing nanoparticle (e.g., transition metal, bimetallic, alloyed, or noble metal systems). The end-functionality can allow for fine-tuning of growing facets and size of nanoparticles. Using the brush architecture and physical dimensions allows for production of nanoparticles with one kind of facet (or predominately one kind of facet), a uniformly sized nanoparticle and enable controlled bi-modal distributions of multifaceted nanoparticles. The bi-modal distributions can be tuned by varying physical dimensions of brush architectures (e.g., grafting architectures on concave and convex sides of a inorganic surface). Grafting of brush architectures on inorganic supports can further allow for the growth of faceted nanoparticles directly on different kind of substrates and morphologies/curvatures (e.g., support nano/micro particles, carbon nanotubes, nanowires, curved surfaces, polymer backbone, etc.). The production of nanoparticles with one kind of facets can be used for catalytic reactions such as alkane dehydrogenation reactions, alkene epoxidation, oxidative coupling of methane, CO₂ reduction, and photocatalytic splitting of water, environmental remediation reactions, and 3-way automotive catalytic reactions. Other applications of nanoparticle-polymer brush architectures include optical film, a plasmonic substrate, a zero Possion's ratio material, a responsive polymer material, a flexible nano-device, a catalytic architecture, a controlled release media, a separation media, a membrane, energy storage, sensor device, medicinal delivery system, or chemical delivery system.

These and other non-limiting aspects of the present invention are discussed in further detail in the following sections with reference to the Figures.

### A. Method For Producing Multifaceted Nanoparticles

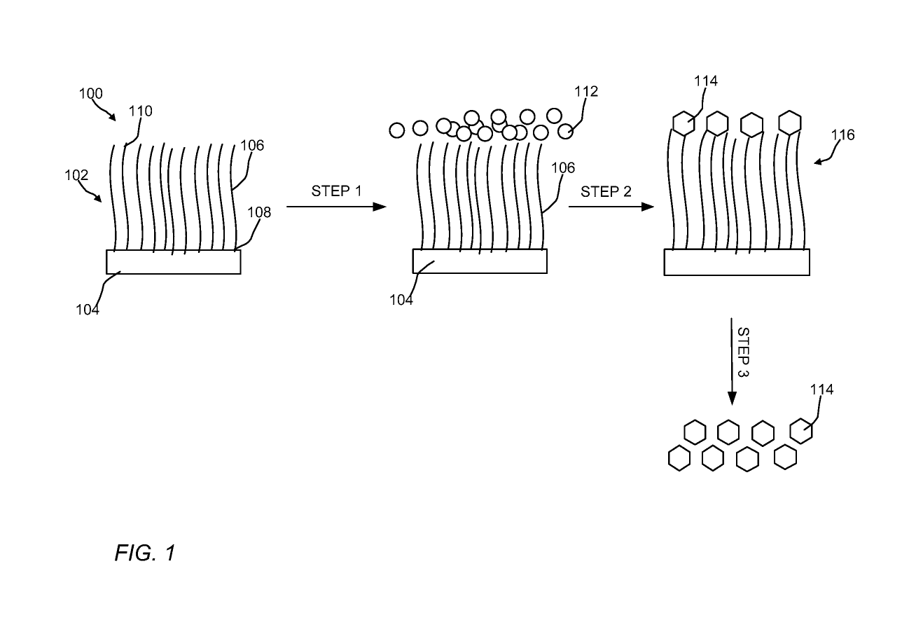

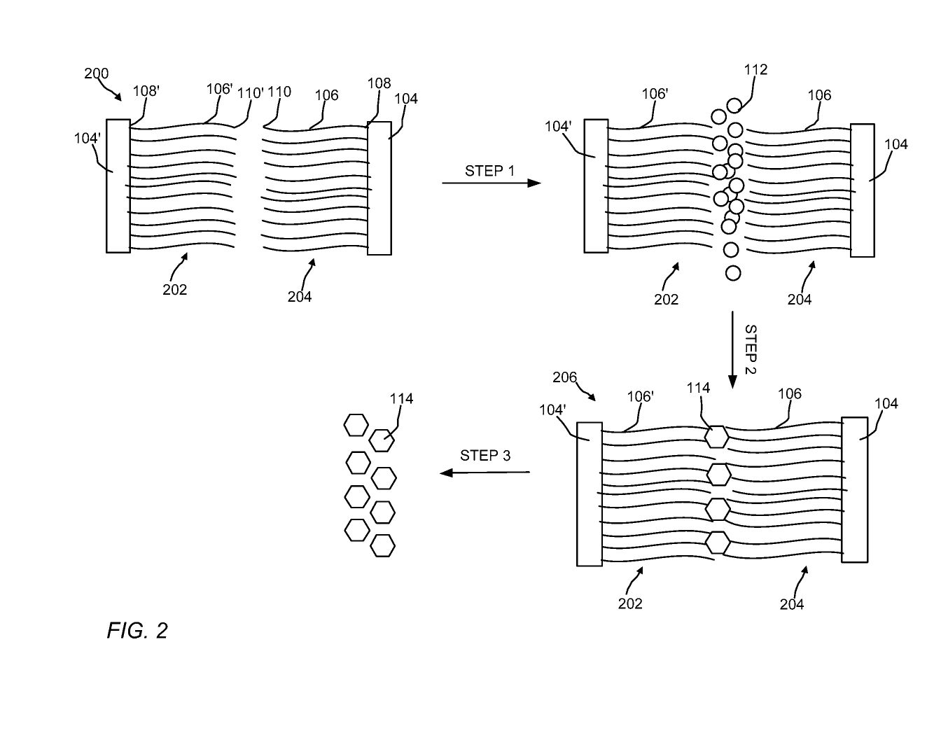

Methods for producing multifaceted nanoparticles include obtaining a template that includes a substrate and a polymer brush having a plurality of polymers chains. The polymer chains are each attached by a first end to the substrate and each polymer chain has a free opposing second end located opposite the first end. The second end of the polymer can be functionalized with a functional group that can guide and tune the growth of the facets on the nanoparticles. The polymer brush can be contacted with a solution that includes a nanoparticle precursor material. FIGS. 1 and 2 are schematics of methods 100 and 200 for producing multifaceted nanoparticles are depicted. Referring to FIG. 1, in method 100, polymer brush 102 can be made or obtained from a commercial vendor and are described in more detail below. The polymer brush 102 can include a substrate 104 and polymeric chains 106 having functional groups. Polymer chains 106 can have a first end 108 attached to the substrate 104 and an opposing second end 110 that located opposite the first end and is not attached to a substrate. Second end 110 can include functionalized groups chosen to assist in the growth of specific facets on the nanoparticles. In some embodiments polymer brush 102 does not include substrate 104. The substrate 104 can be made of inorganic material or organic material. In some instances, the substrate 104 can itself be a polymer that supports or acts as the backbone for the polymer brushes 106. In step 1, the polymer brush 102 can be contacted with nanoparticle precursors 112. The nanoparticle precursors 112 can have an affinity for the functionalized groups on the polymeric chains 106, namely, the second ends 110. Due to the architecture of the polymer brush (e.g., functionalization of the polymeric chains 106, second ends 110, and/or shape of support 104), the nanoparticle precursor material can be converted into multifaceted nanoparticles 114 as depicted in step 2, thereby forming multifaceted nanoparticle composite material 116. In some embodiments, oxygen can be excluded from the step 2 process. For example, a polymer brush solution can be degassed prior to, during, or after step 2. In other aspects, the controlled assembling of nanoparticles can be achieved by manipulating conditions and brush geometry during the faceted-controlled synthesis. In some embodiments, one or more nanoparticle support precursors (e.g., titania or silica precursor via sol-gel) can be added to the polymer brush prior to or during the addition of nanoparticle precursor material 112. Addition of nanoparticle support precursors can facilitate growth of support nanoparticles or a porous matrix simultaneously with the faceted growth of catalytic nanoparticles. The addition of support precursors can also be sequentially accomplished to prevent any hindrance during the faceted growth of nanoparticles. Such a process can be useful for preventing nanoparticle aggregation or assembly changes during the catalytic reactions. In other embodiments, multiple metal precursors could be added simultaneously or sequentially to result in faceted growth of different kind of phase pure nanoparticles.

In optional step 3, the multifaceted nanoparticles 114 can be removed from the polymer brush 102. In certain embodiment, the polymeric brush can be heated in the presence of an inert gas (e.g., nitrogen) to form a protective carbonized/graphitized coating around the nanoparticles. Non-limiting examples of the protective layer include an organic polymer, alkane chains, amorphous carbon or graphene, or inorganic materials such as silica, or an inert metal. These coatings can be porous enough to allow the protected polymer brush to be used in catalytic reactions as the porous shell can allow reactants to reach the catalyst nanoparticles in the polymeric brush. Encapsulating particles within the protective shell can also allow for controlled ordering or assembly of nanoparticles into bigger shapes or pieces (e.g., a wire). Forming a protective, porous shell around the nanoparticles can also prevent any ashing of polymers during the use of the nanoparticles in catalytic reactions. The heating process can also allow for tight adsorption of faceted nanoparticles onto the support substrate to which brushes are grafted. In embodiments when polymers with high flash point and glass transition temperatures are used, the use of support 104 may not be necessary. The multifaceted nanoparticle composite 116 and/or nanoparticles 110 can be used in a various chemical reaction and/or articles of manufacture such as those described throughout this specification.

Referring to FIG. 2, method 200 describes the use of two polymer brushes to produce multifaceted nanoparticles 114. Although not shown, three, four, five, six, seven, eight or more polymer brushes can be used to produce multifaceted nanoparticles 114. The plurality of polymer brushes can be a plurality of the same type of brush or a plurality of different brushes. In preferred embodiments, a plurality of the same type of polymer brush can be used by suspending or dispersing the brushes in a composition that includes the nanoparticle precursor material. As in method 100, polymer brushes 202 and 204 can be obtained from a commercial vendor or produced from polymeric materials. The polymeric brush 202 can include substrate 104 and polymer chains 106 with first polymer ends 108 attached to substrate 104 and opposing second polymer ends 110 opposite the first polymer end 108 and unattached. Polymeric brush 204 can include substrate 104′ and polymer chains 106′ with first polymer ends 108′ attached to substrate 104′ and second opposing polymer ends 110′ opposite the first polymer ends 108′. Second polymer ends 110 and 110′ are not attached to a substrate. In some embodiments, the polymer brushes can respond to various stimuli (e.g., joule heating, electrostatic changes due to pH, pressure, temperature, incident light or the like) that enable alignment of the polymeric chains 106, 106′ opposite of each other. In step 1, the polymer brushes 202 and 204 can be contacted with nanoparticle precursor material 112. As, in method 100, the nanoparticle precursors 112 can have an affinity for the functionalized groups on the second ends 110 and 110′ of polymeric chains 106 and 106′, respectively. Due to the architecture of the polymer brush (e.g., functionalization of the polymeric chains 106 and 106′ and/or second ends 110 and 110′ and the shapes of supports 104 and 104′), the nanoparticle precursor material can be converted into multifaceted nanoparticles 114 as depicted in step 2, thereby forming multifaceted nanoparticle composite material 206. Support precursors, multi-metal precursors can be added during step 2 as previously described for method 100.

Without wishing to be bound by theory, it is believed that the architectures (e.g., the size, spacing and functionality of the polymer chains) of the polymer brushes can push the nanoparticle precursor material to the second ends 110 and/or 110′ of the polymer chains 106 and/or 106′, and, thus, tune the spreading of the second ends 110 and/or 110′ and the entry coefficient of the nanoparticle precursor material 112 into the polymer brush. Such tuning can create faceted growth of nanoparticles while manipulating the reactant concentration around the brush ends (critical reactant concentration). The tunability of brush end functionality and the brush-solvent interfaces can enable faceted growth of nanoparticles in the polymer brush (nano-reactor). The growing nanoparticles can be confined in spaces that will limit their sizes to less than 5 nm. The brush end functionality can adhere to the growing facet of the nanoparticle, thereby, forcing the nanoparticles to grow within the given thermodynamic and kinetic conditions or constraints at the polymeric brush end. Such a forced nucleation and growth can allow for tuning of nanoparticle facet, and/or result in narrow dispersions of one kind of faceted nanoparticles. During the nucleation and growth of the multifaceted nanoparticles, the polymer brush chains and/or nanoparticles can be stabilized through electrostatic and/or solvent interactions.

In some embodiments, the polymeric brushes 102, 202 and 204 can assist in the assembly of nanoparticles into wires and or other materials. For example, nanoparticles can be contacted with the polymer brushes 102, the combination of polymer brushes 202 and 204 or other polymer brushes to be assembled into a wire, film, or the like. In optional step 3, the multifaceted nanoparticles 114 can be treated as described for method 100. The produced multifaceted nanoparticle composites 116 and 206, and/or nanoparticles 114 can be used in a various chemical reaction and/or articles of manufacture as described throughout this specification.

In some embodiments, the polymer brushes can be used to separate a mixture of nanoparticles having different facets. The shape and/or facet selectivity of polymer brush architectures can enable suitable interactions with the specific nanoparticles and trap them while allowing other nanoparticles that do not have suitable interactions remain free from the brushes. In a non-limiting example, a mixture of nanoparticles having different facets can be added to a solution of the polymer brushes 102 or the combination of polymer brushes 202 and 204. Nanoparticles with facets having affinity for the functional groups on the ends 110 and 110′ of polymer chains 106 and/or 106′ can attach or be tightly bound to, or trapped in, the polymer brush while allowing the other nanoparticles that do not have such affinity remain free of the brushes. The nanoparticle/polymer brush composite can then be subjected to separation methods (e.g., centrifuge, filtration, etc.) to separate free nanoparticles from the polymer brush—nanoparticle composite materials in the solution.

### B. Materials

Polymer brushes, functional groups, nanoparticle precursors used in the methods to produce multifaceted nanoparticles are described in the following sections.

1. Polymer Brush

The polymer brush can include architectures (e.g., second ends 110 and 110′ of chains 106 and/or 106′ in FIGS. 1 and 2) that can be synthesized and stabilized in a solution using polymer brush methods known in the art. The architectures can include chains or functional groups that can have one or a combination of one or more of the characteristics. For example, the polymers second ends 110 and 110′ can be functionalized to: 1) have hydrophilic, hydrophobic, lipophilic, lyophobic, amphiphilic properties, or combinations thereof, 2) be suitable for high temperature, and/or 3) have high glass transition properties. In addition, the synthesis conditions (e.g., monomer concentration, temperature, polymerization duration, and the like) to produce the polymer architectures can be adjusted and/or controlled to tune the brush density and length of the polymer chains, inter-brush spacing between polymer chains, and orientation/entanglement of polymer chains.

a. Polymers

Polymers that can be used in the making of the brush architectures include thermoset, thermoplastic polymers and/or thermoresponsive polymers. In some instances, polymers that can sustain combustion environment and high temperatures could be utilized. Thermoset polymers are polymers that cure irreversibly. Thermoset polymers are malleable prior to heating and capable of forming a mold. Thermoset polymeric matrices are cured or become cross-linked and tend to lose the ability to become pliable or moldable at raised temperatures. Non-limiting examples of thermoset polymers used to make the polymer film include epoxy resins, epoxy vinyl esters, alkyds, amino-based polymers (e.g., polyurethanes, urea-formaldehyde), diallyl phthalate, phenolics polymers, polyesters, unsaturated polyester resins, dicyclopentadiene, polyimides, silicon polymers, cyanate esters of polycyanurates, thermosetting polyacrylic resins, polyoxybenzylmethylenglycolanhydride (Bakelite), duroplast, benzoxazines, or co-polymers thereof, or blends thereof.

The matrix can be made from a composition having a thermoplastic polymer and can include other non-thermoplastic polymers, additives, and the like, that can be added to the composition. Thermoplastic polymeric matrices have the ability to become pliable or moldable above a specific temperature and solidify below the temperature. The polymeric matrix of the composites can include thermoplastic or thermoset polymers, co-polymers thereof, and blends thereof that are discussed throughout the present application. Non-limiting examples of thermoplastic polymers include polyethylene terephthalate (PET), a polycarbonate (PC) family of polymers, polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) and their derivatives, thermoplastic elastomer (TPE), terephthalic acid (TPA) elastomers, poly(cyclohexanedimethylene terephthalate) (PCT), polyethylene naphthalate (PEN), polyamide (PA), polysulfone sulfonate (PSS), sulfonates of polysulfones, polyether ether ketone (PEEK), polyether ketone ketone (PEKK), acrylonitrile butyldiene styrene (ABS), polyphenylene sulfide (PPS), co-polymers thereof, or blends thereof. In addition to these, other thermoplastic polymers known to those of skill in the art, and those hereinafter developed, can also be used in the context of the present invention. In some aspects of the invention, the preferred thermoplastic polymers include poly-norborene-poly-isoprene, poly((2-(methacryloyloxy)ethyl)-trimethylammonium chloride) (PMETAC), poly(2-hydroxyethyl methacrylate) (PHEMA), alkylthiols, phenylsulfonates, alkylphosphonates, alkylamines, and fluoroalkyls, norborene-polystyrene based, poly(N,N-dimethylaminoethyl methacrylate), poly-(styrene-b-methyl methacrylate) (PS-b-PMMA), poly(styrene-b-isoprene) (PS-b-PI), poly(styrene-b-butadiene) (PS-b-PB), poly(2-vinylpyridine-b-styrene) (P2VP-b-PS), poly(4-vinylpyridine-b-styrene) (P4VP-b-PS), poly(ethylene) oxide (PEO), poly(ethylene) glycol, Poly (N, N-dimethylacrylamide)(PDMA), polyethylene terephthalate (PET), polypropylene (PP) or blends thereof. The thermoplastic polymer can be included in a composition that includes said polymer and additives. Non-limiting examples of additives include coupling agents, antioxidants, heat stabilizers, flow modifiers, colorants, etc., or any combinations thereof.

A thermoresponsive polymer is a polymer that can changes its physical properties (e.g., hydrophilicity and hydrophobicity) in response to temperature. Non-limiting examples of thermoresponsive polymers include poly(N-isopropyl acrylamide) (PNIPAAm), poly[2-dimethylamino)ethyl methacrylate] (pDMAEMA), hydroxpopylcellulose, polyvinylcaprolactame, polyvinyl methyl ether, copolymers thereof, terpolymers thereof, and the like. In a preferred embodiment, PNIPAAm is used.

In some embodiments, one or more monomers or polymers capable of being polymerized when exposed to heat, light or electromagnetic force are used. Monomers can be precursor materials suitable for forming polymers used for the polymer brushes. The monomers are available from commercial vendors or are made according to conventional chemical reactions. In some instances, monomers with catalyst loading much higher than needed to form the polymer brush, but sufficient to generate additional nanoparticles that can be of use in the other applications described throughout the specification, can be used. The use of catalyst-loaded monomers can provide the advantage of simultaneously prepping the desired facet nanoparticles for further use beyond the polymer synthesis.

In some embodiments, the polymeric matrix includes a cross-linking or grafting agent. Upon exposure to heat, light, electromagnetic force, or chemicals, the polymer matrix can become crosslinked to obtain a polymer matrix high melt strength (or high extensional viscosity) property. Such cross-linking can lead to long chain branching polymeric matrixes that can be used in extrusion applications such as blown and/or casting films, plastic sheet, foams, and blow molding application.

b. Functional Groups

The end or tip of the polymeric chain can include a specific end-functionality, which can impart specific interactions necessary to control and/or tune the faceted growth of nanoparticles to obtain the desired multifaceted nanoparticles. The unattached end (second end) of the polymeric chains can be derivatized with the functional groups using methods known in the art of organic chemistry (e.g., esterification, alkylation, amidization, imidization reactions and the like). In some embodiments, the end of the polymer chain includes the functional group (e.g., —COOH) and no further derivatization is necessary. Non-limiting examples of functional groups include amines, phosphorous, thiols, alkyls, halides, hydrogen sulfite, phosphate, carboxylic acids, alcohols, polyols, alkyl sulfates, quaternary ammonium salts, or combinations thereof. In some embodiments, a commercially available polymer brush having a wide spacing between the brush tips and dangling functionalities along the length (e.g., —OH, —COOH, NH₂, SH, etc.) can be derivatized with specific functional groups for production of nanoparticles with a desired number and/or facet shapes. For example, —COOH groups on the sides of brush could be linked with diamine by using carbodiimide chemistry. Modification of the polymer ends in such a manner can allow for tuning the spacing, chemistry, and crowding of polymer brushes, thereby eliminating the need of complex manipulation of brush-polymer-nanoparticle interface to push the nanoparticles to the tips of brushes.

Without wishing to be bound by theory, it is believed that the nanoparticle precursors are attracted to or has an affinity for the functional group. The functional group can “hold” the nanoparticle in place and/or facilitate nucleation of the nanoparticle while controlling the shape and size of the nanoparticle. Table 1 lists a table of functional groups and the nanoparticle material that the functional group used to produce the desired facets and nanoparticle shape.

TABLE 1

| Structure directing agent, | | | |
|---|---|---|---|
| surfactant, or functionality | Nanoparticle material | Facets grown | Shape |
| Cetyltrimethylammonium bromide | Noble/precious metal | various | Spherical, rod |
| (CTAB) | group | | |
| Sodium dodecylsulfate | Noble/precious metal | various | spherical |
| | group | | |
| Bis(2-ethylhexyl) | Au, Cu - and other | Low energy facets | rods |
| sulfosuccinate | noble/precious and | | |
| | transition metals | | |
| Tetradodecylammonium bromide | Noble/precious metal | Low energy facets | rods |
| | group | | |
| Polyvinyl pyrrolidone (PVP) | Noble/precious metal | (111), (110), | rods, wires, cubes, |
| | group | (100) | octahedra, |
| | | | tetrahedra, |
| | | | icosahedra, |
| | | | and other |
| | | | polyhedra |
| Ethylene glycol, 1,2-propylene | Noble/precious metal, | various | Spherical, rods |
| glycol, and 1,5-pentanediol | oxides | | |
| 3-Mercaptopropionate | Noble/precious metal | (111) | spherical |
| | group | | |
| Octadecanethiol, dodecanethiol, | Noble/precious metal | various | various |
| octanethiol, mercaptopropionic | group | | |
| acid, sodium 4-mercaptobenzoate, | | | |
| and sodium mercaptoethanoate | | | |
| (Amidoferrocenyl) alkanethiol- | Noble/precious metal | various | various |
| type ligands | group | | |
| Octadecylamine/Trioctylphosphine | Noble/precious metal | Low energy facet | Hexagonal |
| oxide (TOPO) | group | | |
| Monohydroxy (1-mercaptoundec- | Noble/precious metal | | Hexagonal |
| 11-yl) | group | | |
| tetraethylene glycol | | | |
| Ethylenediaminetetraacetic | Noble/precious metal | various | various |
| acid (EDTA) | group | | |
| Organosilanes with amine, thio, | Noble/precious metal | various | various |
| carboxylic, and other end groups | group, oxides | | |
| Dodecylamine | PbS, Fe₂O₃ | (111) | Cubic for PbS |
| | | | sphere, triangle, |
| | | | diamond, and |
| | | | hexagon for Fe₂O₃ |
| Dodecanethiol with different | PbS | (111) | tadpole-shaped |
| temperatures | | | monorods, I- |
| | | | shaped bipods, L- |
| | | | shaped bipods, T- |
| | | | shaped tripods, |
| | | | crossshaped |
| | | | tetrapods, and |
| | | | pentapods, |
| | | | octahedron, |
| | | | tetradecahedron |
| Hexylphosphonic | CdSe | (002), (001) | Rod, arrow, pencil |
| Acid, trioctylphosphine oxide | | | shaped |
| Octadecanoate | NiS | (110) | Rod |
| Oleic acid and | PbSe | various | Ziz zag nanowire |
| tetradecylphosphonic acid | | | |
| Trioctylamine | GaP | various | sphere |
| Trioctylphosphine oxide, TOPO | TiO₂, numerous oxides | various | sphere |
| | and phosphide | | |
| | nanostructures | | |
| Octadecene containing oleic | Gd₂O₃ | (100) | nanoplates |
| acid and oleylamine surfactants | | | |
| oleic acid and oleylamine | Ln₂O₃ | (110), (100) | Cubic, plate, disc |
| | (Ln═La, Pr, Nd, Sm, | | |
| | Eu, Gd, Tb, Er, Y) | | |
| Benzyl dimethyl hexadecyl | Precious metal group | (111) | Sphere, triangular, |
| ammonium chloride | | | plate-like, wires |
| 1,4-Benzyne dithiol (BDT), 4- | Precious metal group | Low energy facets | various |
| mercaptobenzoic acid (MBA), 4- | | | |
| aminothiophenol (ATP) | | | |

c. Substrates

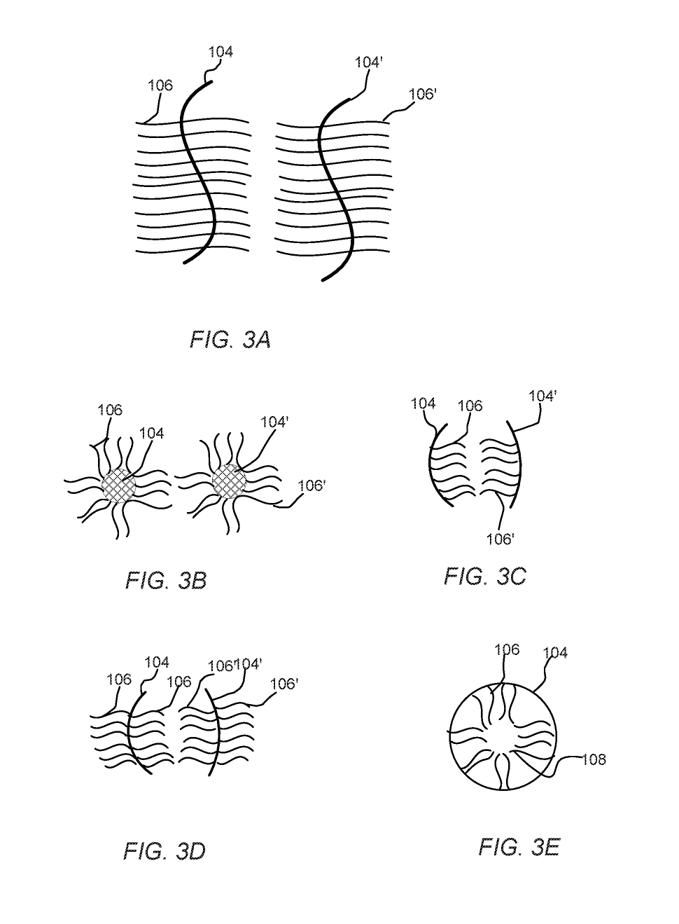

The polymer brushes can be attached (e.g., grafted) to a substrate using techniques known in the art of polymer chemistry. In some aspects, no substrate is necessary (for example, when polymers having high glass transition temperatures are used). The ability to use various shaped polymer brush architectures can allow tunability of facets and nanoparticle growth. For example, a curved support having polymer brushes on the concave and convex sides can allow for larger particle growth on the concave side and smaller particle growth on the convex side. The substrate can be a carbon nanotube, a nanorod, a quantum dot, a hollow shell, a nanostructure, a polymer chain, a microstructure, a microtube, a microwire, a microrod, or any combination thereof. In some instances, polymer brush architectures can be patterned on a substrate. The substrate can be flexible or rigid, however, a flexible substrate is preferred. Substrates can be made or purchased from a commercial vendor. The substrate can have various sizes and shapes and be chosen to fit the desired application. The substrate can have a surface that is planar, spherical, curved (e.g., concave, convex, elliptical, parabolic) or the like. One end of the polymer chain can be attached to the surface of the substrate. As shown in FIGS. 1 and 2, the first ends 108 and 108′ of the polymer chains are attached to a substantially planar surface. FIGS. 3A-3D are illustrations of the polymer chains attached to a concave polymer chain (FIG. 3A), attached to a spherical surface (FIG. 3B), attached to a curved (FIG. 3C), attached to a concave and a convex surface (FIG. 3D) and attached to an inside surface of a hollow shell. In FIG. 3A, polymer chains 106 and 106′ are grafted on a backbone of polymeric substrate 104 and 104′, respectively. FIG. 3B depicts polymer chains 106 and 106′ attached to spherical substrate 104 and 104′, respectively. FIG. 3C depicts polymer chains 106 and 106′ attached to the concave surface of substrates 104 and 104′, respectively. FIG. 3D depicts polymer chains 106 and 106′ attached to the concave (inner) and convex (outer) surface of substrates 104 and 104′, respectively. FIG. 3E depicts a hollow shell substrate 104 and the first ends 108 of the polymer chains 106 are attached to the inside surface of the hollow shell. In some embodiments, the polymer chains 106 are attached to the outside surface of the hollow shell substrate 104 or both the inside and outside surfaces of the hollow shell.

d. Metals and Metal Precursors and Metal Oxides

The nanoparticles can include metal or an oxide or alloy thereof. The metal can include noble metals, transition metals, or any combinations or any alloys thereof. Noble metals include gold (Au), silver (Ag), palladium (Pd), platinum (Pt), rhodium (Rh), ruthenium (Ru), rhenium (Re), iridium (Ir), osmium (Os), or any combinations or alloys thereof. Transition metals include iron (Fe), copper (Cu), nickel (Ni), zinc (Zn), manganese (Mn), chromium (Cr), molybdenum (Mo), tungsten (W), or tin (Sn), or any combinations or alloys thereof. In some embodiments, the catalyst includes 1, 2, 3, 4, 5, 6, or more transition metals and/or 1, 2, 3, 4 or more noble metals in addition to gold. The metals can be obtained from metal precursor compounds. For example, the metals can be obtained as a metal nitrate, a metal amine, a metal chloride, a metal coordination complex, a metal sulfate, a metal phosphate hydrate, metal complex, or any combination thereof. Examples of metal precursor compounds include, chloroauric acid, nickel nitrate hexahydrate, nickel chloride, cobalt nitrate hexahydrate, cobalt chloride hexahydrate, cobalt sulfate heptahydrate, cobalt phosphate hydrate, platinum (IV) chloride, ammonium hexachloroplatinate (IV), sodium hexachloroplatinate (IV) hexahydrate, potassium hexachloroplatinate (IV), or chloroplatinic acid hexahydrate. These metals or metal compounds can be purchased from any chemical supplier such as Sigma-Aldrich (St. Louis, Mo., USA), Alfa-Aeaser (Ward Hill, Mass., USA), and Strem Chemicals (Newburyport, Mass., USA).

Metal oxides such as alpha, beta or gamma alumina (Al₂O₃), activated Al₂O₃, silicon dioxide (silica, SiO₂), cerium oxide (CeO₂), titanium dioxide (titania, TiO₂), zirconia (ZrO₂), germania (GeO₂), tin oxide (SnO₂), gallium oxide (Ga₂O₃), zinc oxide (ZnO), hafnium oxide (HfO₂), yttrium oxide (Y₂O₃), lanthanum oxide (La₂O₃), cerium oxide (CeO₂), or combinations thereof can be used. In general, the alumina sols of the present invention may be prepared by the hydrolysis and peptization of the corresponding organo-metallic compounds in an aqueous medium. Non-limiting organo-metallic compounds are aluminum nitrates, aluminum alkoxides, and the aluminum sec-butoxides, ethoxides, and methoxides. The silica gel components may be prepared from the corresponding silanes, such as tetraethyl orthosilicate (TEOS), tetramethyl orthosilicate (TMOS), methyltirethoxsiliane (MTES), methyl trimethoxiysilane (MTMS), vinyl trimethoxysilane (VTMS), 3-aminopropoyl trimethoxysilane (APS), gamma-metaacryloxyporpoyl trimethoxysilane (gamma-MAPTS).

### C. Multifaceted Nanoparticles

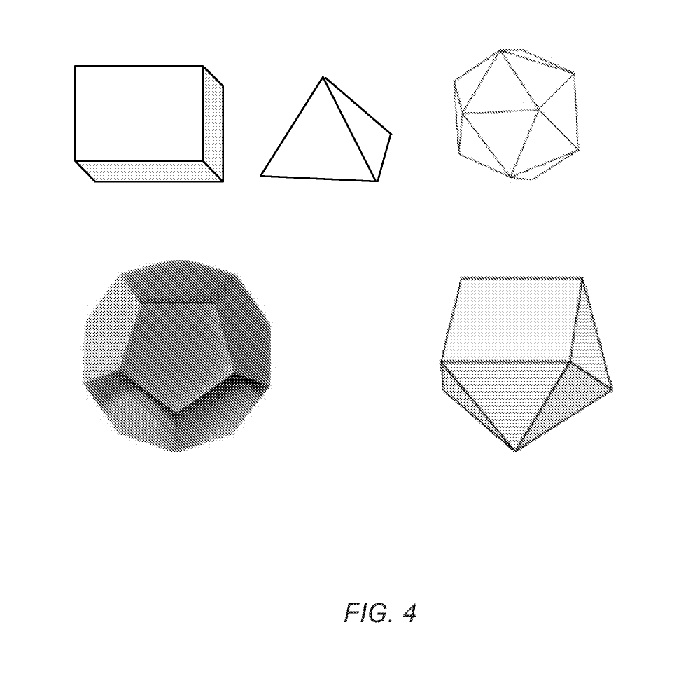

The multifaceted nanoparticles produce from the methods described above can have any desired shape, size, and number of facets. Non-limiting examples of shapes include platelet shape, an elongated rod shape, hexagonal shape, octagonal shape, heptagonal shape, square shape, triangular shape, rectangular shape, trapezoid shape, an oval shape or combinations thereof. In some embodiments, the size and/or shape of the facets are substantially uniform. In certain embodiments, the multifaceted nanoparticle can have a spherical shape with an average diameter of 100 nm or less, preferably 1 nm to 20 nm, or more preferably 1 nm to 5 nm or 20 nm, 19 nm, 18 nm, 17 nm, 16 nm, 15 nm, 14 nm, 13 nm, 12 nm, 11 nm, 10 nm, 9 nm, 8 nm, 7 nm, 6 nm, 5 nm, 4 nm, 3 nm, 2 nm 1 nm, 05 nm or less. The nanoparticles can have 2 to 8 facets, 3 to 8, 2 to 6, or 2, 3, 4, 5, 6, 7 8 facets. FIG. 4 depicts illustrations of various multifaceted particles.

### D. Use of the Multifaceted Nanoparticles

The produced multifaceted nanoparticles can be used in a variety of chemical reactions. Non-limiting examples of chemical reactions include a hydrocarbon hydroforming reaction, a hydrocarbon hydrocracking reaction, a hydrogenation of hydrocarbon reaction, a dehydrogenation of hydrocarbon reaction, an alkene epoxidation reaction, an oxidative coupling of methane reaction, a carbon dioxide reduction reaction, an environmental remediation reaction, a 3-way automobile catalytic convertor reaction and/or a photocatalytic splitting of water. The methods used to prepare the multifaceted nanoparticle catalysts can tune the size and shape of the nanoparticles, the number, size and shape of the facets, the catalytic metal particles, and the size of the catalytic metal to produce highly reactive and stable multifaceted nanoparticle catalysts for use in a chosen chemical reaction.

The produced multifaceted nanoparticles and/or produced the multifaceted nanoparticle composites can also be used in a variety of electronic applications, energy generation and storage applications, plasmonic applications, optical applications, and/or controlled release applications. In some aspects, the articles of manufacture are an optical film, a plasmonic substrate, a zero Possion's ratio material, a responsive polymer material, a flexible nano-device, a catalytic architecture, a controlled release media, a separation media, a membrane, energy storage, sensor device, medicinal delivery system, or chemical delivery system. In some instances, the polymer brush architectures are grafted on inorganic supports or other polymers that can allow for the growth of the faceted nanoparticles directly on different kinds of article of manufacture substrates having different morphologies and curvatures, to directly incorporate the multifaceted nanoparticle in the article of manufacture. A chemical delivery system can include a lubricating agent. For example, nanoparticles with polymer brush can be used as lubricating agents for polymer processing and final applications. Multifaceted nanoparticle can be used as an alternative to polyvinyl chloride polymers for polyolefin printing applications.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### Materials and Instruments

Materials.

Graphite, sodium nitrate (NaNO₃), potassium permanganate (KMNO₄), dichloromethane, methanol, and sulfuric acid were obtained from Fisher Scientific (U.S.A.). Chloroplatinic acid (H₂PtCl₆), sodium borohydride (NaBH₄), poly(acrylic acid) (PAA), sodium carbonate (Na₂CO₃), sodium bicarbonate (NaHCO₃), 2-hydroxyethyl methacrylate (HEMA), methyl methacrylate (MMA), N-isoprpylacrylamide (NIPAAm), aminopropyltriethoxysilane (APTES), 2-bromoisbutryl bromide (BiBBS), pyridine, 1,1,4, 7,7-pentamethyldiethylenetriamine (PMDETA), dimethylsulfoxide, chloroauric acid (HAuCl₄), and a copper plate were obtained from Sigma-Aldrich® (U.S.A.). Alumina nanoparticles were obtained from ACS Materials® (U.S.A.). Silicon wafers were obtained from International Wafer Service (U.S.A.).

Instruments.

Optical microscopy images were obtained with a Zeiss Microscope, Axio Imager M2M (Carl Zeiss Microscopy GmBH, Germany). Scanning Electron Microscopy (SEM) and Energy Dispersive Spectroscopy (EDS) images were obtained using a JEOL 7800F (JEOL Instruments, U.S.A.). Transmission electron microscope (TEM) images were obtained using a JEOL 2010F (JEOL Instruments, U.S.A.).

### Example 1

### Grafting of PAA Polymer Brushes with Pt Nanoparticles onto Alumina Nanoparticle

Alumina nanoparticles (2 to 5 mg) were dispersed in a buffer solution (pH about 9.2, 10-50 mL). The nanoparticles were stabilized in the solution by stirring for 24 hrs. To this stabilized solution, polyacrylic acid (1.2 mg) was added and stirred for 24 hrs. This resulted in PAA grafted alumina nanoparticles stabilized in the solution. The stable suspension of PAA-grafted alumina nanoparticles (10-20 mL) was mixed with metal salt solution (H₂PtCl₆, 8% in water, 30-500 μL or 2-3 mg of HAuCl₄) for 100 min. A NaBH₄ solution (1 ml of 1.9 mg NaBH₄ in 1 ml water) was added to reduce the metal salt solution into metal (e.g., Pt) nanoparticles decorated PAA-grafted alumina nanoparticles. This reaction was allowed to occur for 15-20 min. The solution color changed from turbid white to faint brown once the nanoparticles nucleated. The solution was centrifuged washed at 3500 rpm (for 1 hr), collected, and dried at 70° C. in air.

### Example 2

### Template Production: Growth of Polymer Brushes on a Silicon Substrates

The polymer brush synthesis and grafting method (See, Table 2) are adopted from Zhang et al., Polymer Chem, 2015, 6, 2726. Surface-oxidized silicon wafer was piranha cleaned (in solution comprised of H₂O₂: H₂SO₄ was 1:3 v/v), at 90° C. for 45 min. The wafer was washed extensively with deionized water and dried with a jet of nitrogen. The dried substrate was functionalized with APTES by immersing in APTES solution (5% in acetone (v/v) and sonicated for 60 min. Subsequently, the substrate was washed with acetone and dried under a nitrogen jet. The substrate, with self-assembled monolayers of APTES, was immersed in 20 ml dichloromethane under a nitrogen atmosphere. Pyridine (0.4 ml) was added to the solution, followed by slow addition of BiBB (20 ml, 2% in dichloromethane) at ice temperature for 24 hrs under stirring. The resulting substrate was washed with dichloromethane, water, and acetone and dried afterwards in a jet of nitrogen.

The silicon substrate functionalized with APTES-BiBB was sandwiched with a copper plate (or glass slide with copper tape) via a paper clip and with a spacer (<0.5 mm) between the two. This assembly was immersed in the polymer brush precursor solution (polymer precursor solutions listed in Table 2 in methanol/water (1:2 v/v, a total of 5 mL), and stirred for 1 hr at room temperature.

TABLE 2

| | |
|---|---|
| PMMA | 1 mL monomer (MMA), 0.5 ml DMSO, 18.4 μL PMDETA |
| brush | |
| NIPAAm | 0.5 g monomer, 1 mL H₂O and 0.5 mL MeOH, 18.4 |
| brush | μLPMDETA. |
| PHEMA | 1 mL monomer (HEMA), 1 mL H2O and 0.5 mL MeOH, |
| brush | 18.4 μL PMDETA |

### Example 3

### Template Production: Growth of Polymer Brushes on a Graphene Substrates

Graphene oxide flakes were prepared by partial Hummer's method and thermal exfoliation. Graphite flakes (10 mesh, 10-20 gm) were added to the round bottom flask. Sodium nitrate (NaNO₃, 10-20 gm) was added next to the flask. The flask was lowered into an ice bath and 98% sulfuric acid (H₂SO₄) was slowly added to the flask. The mixture was vigorously agitated for 10-15 min. Subsequently, 10-15 gm of potassium permanganate (KMnO4) was slowly added to the agitated mixture. The temperature was not allowed to go above 20° C. After the addition, the ice bath was removed for the temperature (due to endothermic reaction) to rise up to 70-80° C. and held for 10 min. The resulting black colored suspension was diluted with water, centrifuged, and washed multiple times. The obtained precipitate after washing was further heated slowly at 120 to 150° C. to exfoliate the graphene oxide flakes.

The procedure of Example 2 was followed to grow polymer brushes on a graphene substrate. The graphene substrate was functionalized with APTES by immersing in APTES solution (5% in acetone (v/v) and sonicated for 60 min. Subsequently, the substrate was washed with acetone and dried under a nitrogen jet. The substrate, with self-assembled monolayers of APTES, was immersed in 20 ml dichloromethane under a nitrogen atmosphere. Pyridine (0.4 ml) was added to the solution, followed by slow addition of BiBB (20 ml, 2% in dichloromethane) at ice temperature for 24 hrs under stirring. The resulting substrate was washed with dichloromethane, water, and acetone and dried afterwards in jet of nitrogen.

The graphene substrate functionalized with APTES-BiBB were immersed in the polymer brush precursor solution listed in Table 2 along with numerous copper plates (>20 1 cm×1 cm). This enabled effective contact of individual nanostructures with the copper plate and facilitated growth of polymer brush on the former. After the reaction was completed, the substrate was collected and separated from the copper plates. The substrate was washed/centrifuged with DMS or methanol/water mixture, ultrasonicated for 5 min, and dried in a jet of nitrogen.

### Example 4

### Template Production: Growth of Polymer Brushes on a Alumina Nanoparticles

The procedure of Example 2 was followed to grow polymer brushes on an alumina substrate. The alumina substrate was functionalized with APTES by immersing in APTES solution (5% in acetone (v/v) and sonicated for 60 min. Subsequently, the substrate was washed with acetone and dried under a nitrogen jet. The substrate, with self-assembled monolayers of APTES, was immersed in 20 ml dichloromethane under a nitrogen atmosphere. Pyridine (0.4 ml) was added to the solution, followed by slow addition of BiBB (20 ml, 2% in dichloromethane) at ice temperature for 24 hrs under stirring. The resulting substrate was washed with dichloromethane, water, and acetone and dried afterwards in jet of nitrogen.

The alumina substrate functionalized with APTES-BiBB were immersed in the polymer brush precursor solution listed above along with numerous copper plates (>20 1 cm×1 cm). This enabled effective contact of individual nanostructures with the copper plate and facilitated growth of polymer brush on the former. After the reaction was completed, the substrate was collected and separated from the copper plates. The substrate was finally washed/centrifuged with DMS or methanol/water mixture, ultrasonicated for 5 min, and dried in jet of nitrogen.

### Example 5

### Characterization of Polymer Brushes

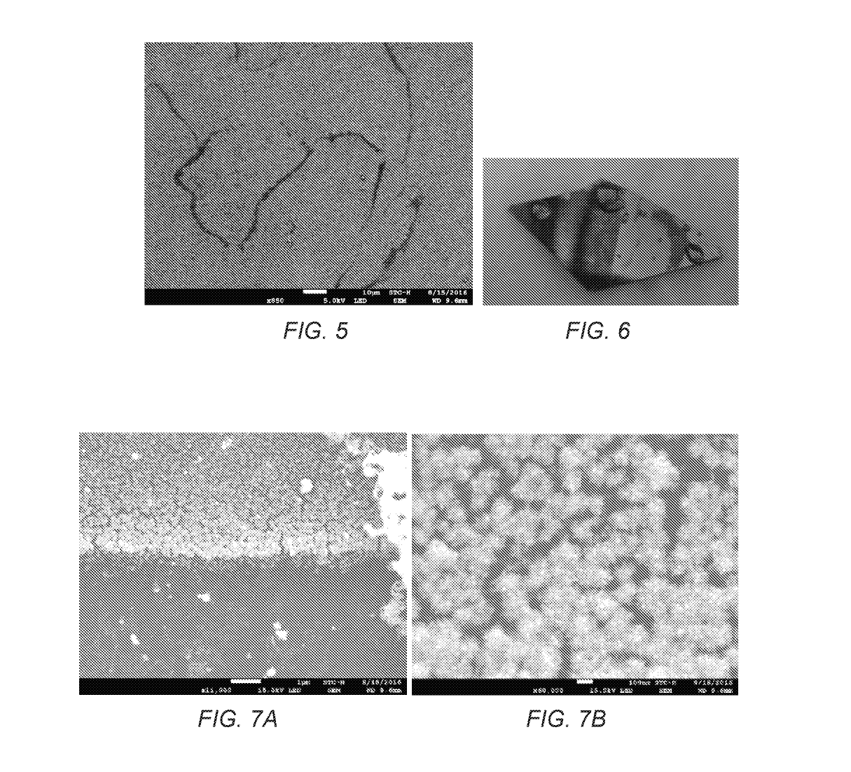

SEM analysis was performed on a PMMA brushes grated on the silicon wafer as made in Example 2. FIG. 5 is an SEM image of the PMMA brushes grafted on the silicon wafer. FIG. 6 is a digital image of the PMMA brushes on the silicon wafer. The color variation (darker lines) in both images confirmed the formation of brushes.

### Example 6

### Growth of Nanoparticles Between the Polymer Brushes Silicon Grafted Substrates

Two polymer brush grafted surfaces were held facing each other using a paper clip. The nanoparticle precursor solution (10 μL) and reducing agent (NaBH4, 10 μL) was inserted between the space and the nanoparticle growth was allowed to occur for 15-20 min. Once the growth was completed, the substrates were separated and washed with copious amounts of DI water.

### Example 7

### Growth of Nanoparticles Between the Polymer Brushes Alumina or Graphene Grafted Substrates

The polymer brush grafted alumina particles or graphene systems were dispersed in water medium (32 ml) and briefly sonicated. A H₂PtCl₆ (30-500 μl) solution was added and stirred for 2 hrs. Subsequently, NaBH₄ in water (2-3 mg, 1 ml) was added, and the reaction was held for 15-20 min. The solution was centrifuged and washed at 3500-5000 rpm (for 1 hr) and finally, collected and dried at 70° C. in air.

### Example 8

### Characterization of Nanoparticles Between Polymer Brushes Grafted on Silicon Wafers from Example 6

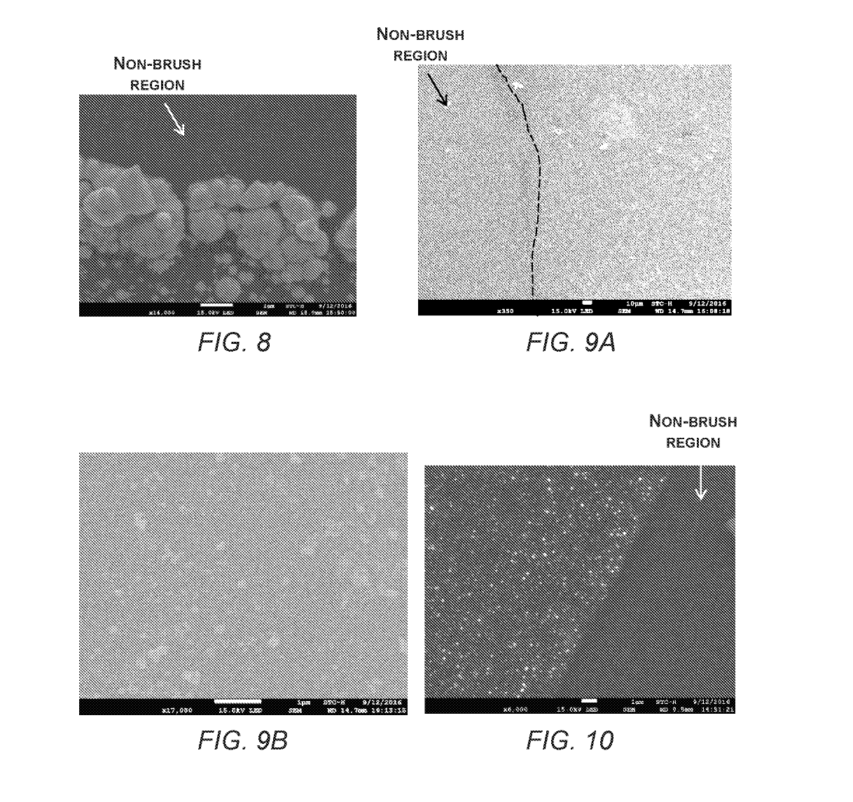

FIGS. 7A and 7B are SEM images of Pt nanoparticles between PMMA brushes grated on a silicon wafer at different 1 micron and 100 nm magnifications, respectively. As shown in FIG. 7A there was a demarcation of brush and non-brush region (gray area). The brush region appeared after growth of Pt nanoparticles. The Pt nanoparticles were determined to be less than 10 nm and uniformly dispersed. FIG. 8 is an SEM image of Pt nanoparticles between PHEMA brushes grated on a silicon wafer. Using PHEMA resulted in faceted Pt nano and microparticles, and uniform dispersions of nanoparticles in the brush-grafted region. Without wishing to be bound by theory, it is believed that the highly hydrophilic PHEMA regions facilitated wetting of the Pt nanoparticles. Faceting of nanoparticles at the edges was clearly observed. FIGS. 9A and 9B are an SEM image of a gold nanoparticle between BiBBs functionalized a silicon wafer. FIG. 9A is the SEM image of the non-brush region (left of dashed line) and brush-grafted region. FIG. 9B is the SEM image of the brush-grafted at higher magnification. BiBBs functionalization resulted in faceted Au nanoparticles, and uniform dispersions of nanoparticles in the brush-grafted region. FIG. 10 is an SEM image of Pt nanoparticles between NIPAAM brushes grafted on the silicon wafer.

### Example 9

### Characterization of Nanoparticles Between Polymer Brushes Grafted on Graphene Oxide from Example 7

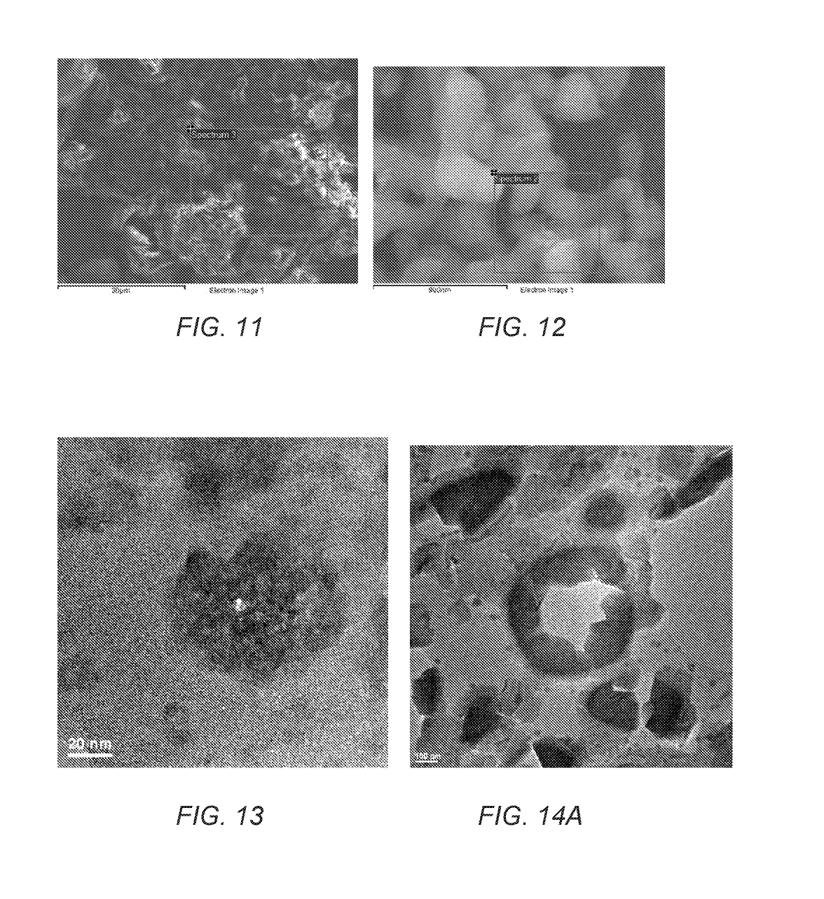

FIG. 11 is a SEM of PMMA brush grafted on graphene oxide flakes with Pt nanoparticles. Table 3 is the EDX data of the area inside the box on the electron image.

TABLE 3

| Element | Weight % | Atomic % |
|---|---|---|
| C K | 59.44 | 76.33 |
| O K | 22.26 | 21.47 |
| Si K | 1.60 | 0.88 |
| Pt M | 16.70 | 1.32 |
| Totals | 100.00 | |

### Example 10

### Characterization of Nanoparticles Between Polymer Brushes Grafted on Alumina Nanoparticles from Example 7

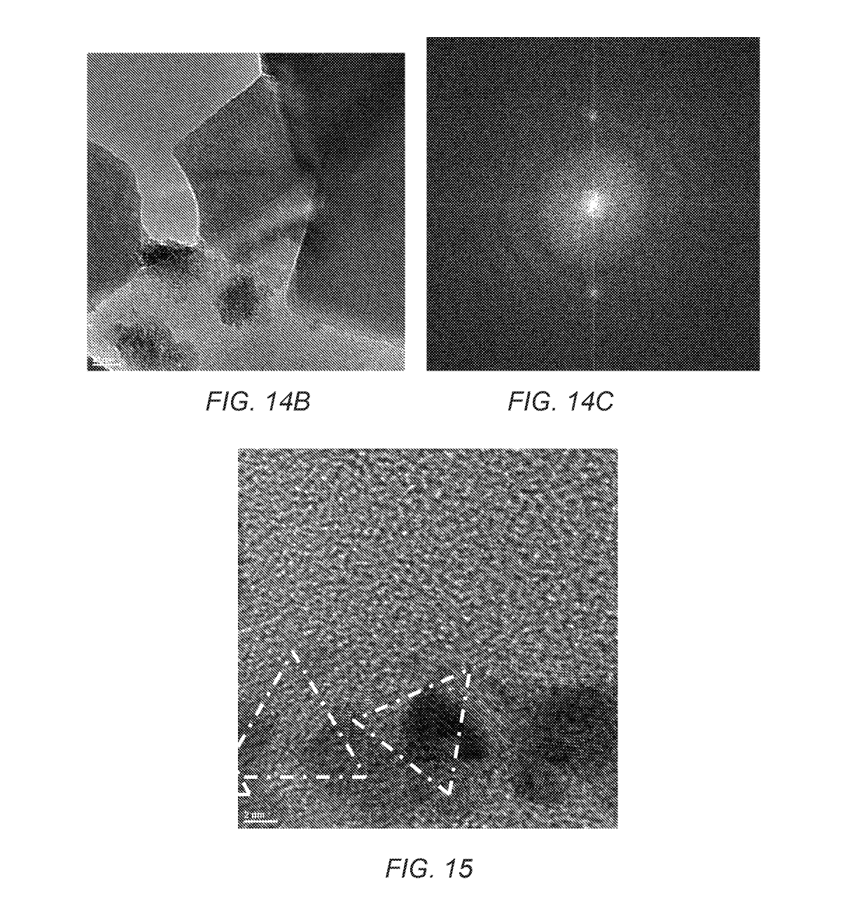

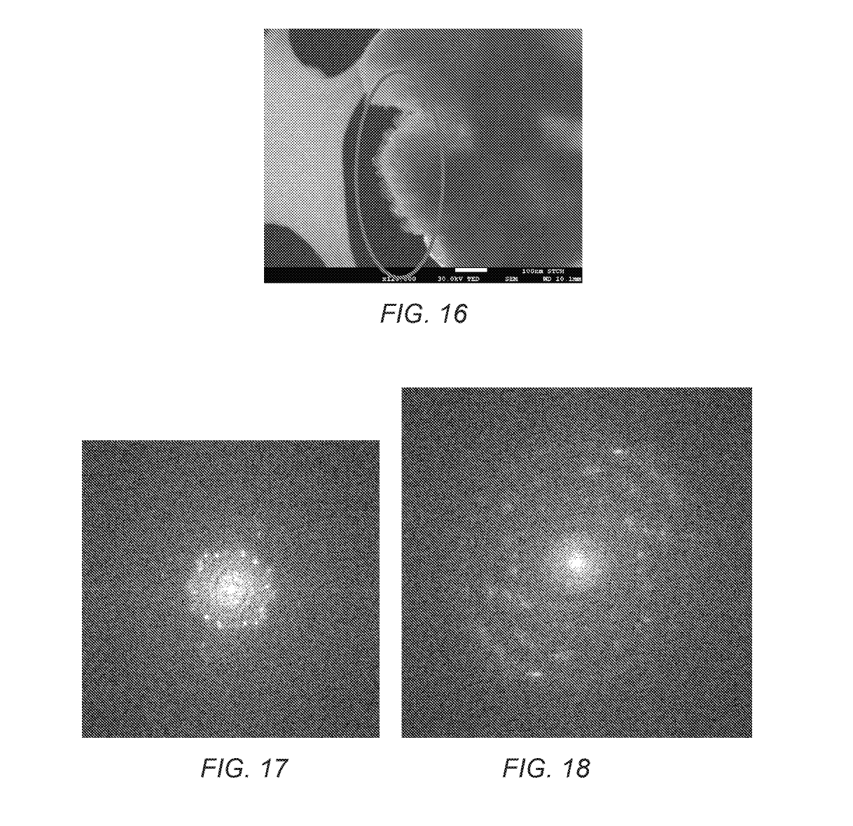

FIG. 12 is a SEM PMMA brush grafted on alumina nanoparticles with Pt nanoparticles grown in a free solution as described above. Table 4 is the EDX data of area inside the box in the image of the particle. FIG. 13 is TEM image of an alumina nanoparticles coated with <2 nm Pt nanoparticles. Some shaped nanoparticles were observed at the edges. The free-solution growth of Pt nanoparticles (FIG. 12) resulted in randomly aggregated nanoparticles as compared to the coated sample, where Pt nanoparticles are specifically aggregating around PMMA-grafted alumina nanoparticles. FIGS. 14A, 14B, are TEM images and FIG. 14C is FFT image of alumina nanoparticles grafted with PHEMA for Pt nanoparticle growth. FIG. 14A shows a hollow shell formation with Pt nanoparticles at the outer edges. FIG. 14B show Pt nanoparticles between two alumina nanoparticles. FIG. 14C shows symmetrical spots (bright spots) for Pt nanoparticles. The symmetrical geometry was determined to indicate that the use of PHEMA achieved facet control. FIG. 15 is a TEM image of alumina nanoparticles grafted with PNIPAAM for Pt nano growth. The Pt nanoparticles had triangular shapes. FIG. 16 is a SEM of alumina nanoparticles grafted with polyacrylic acid for Pt nanoparticle growth. The bright spots (inside the eclipse) on the brushed are nucleated Pt nanoparticles.

TABLE 3

| Element | Weight % | Atomic % |
|---|---|---|
| C K | 19.21 | 30.92 |
| O K | 25.89 | 31.30 |
| Al K | 7.31 | 5.24 |
| Si K | 47.22 | 32.51 |
| Pt M | 0.37 | 0.04 |
| Totals | 100.00 | |

### Example 11

### Characterization of Nanoparticles Between PAA Brushes Grafted on Alumina Nanoparticles Compared to Non-PAA Grafted Nanoparticles

FIG. 17 is a FFT image of a PAA grafted alumina nanoparticles decorated with Pt nanoparticles from Example 7. FIG. 18 is a FFT image of alumina nanoparticles (no PAA) with Pt nanoparticles. In FIG. 17, the limited number of orderly spots shown indicates relatively (as compared to non-PAA grafted system FIG. 18) less number of facets evolved. In FIG. 18, the Pt nanoparticles were not decorated on the alumina nanoparticles, but rather aggregated together. This electron diffraction showed significant number of spots indicating many facets of Pt nanoparticles.

### Example 12

### Control Sample-Pt Nanoparticles Grown in a Free Solution

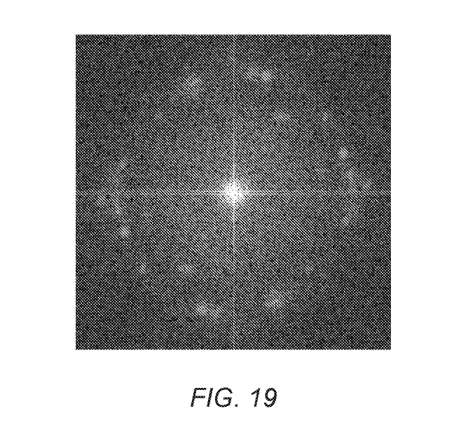

Alumina nanoparticles and a H₂PtCl₆ (30-500 μl) solution was stirred for 2 hrs. Subsequently, NaBH₄ in water (2-3 mg, 1 ml) was added and the reaction was allowed for 15-20 min. The solution was centrifuged and washed at 3500-5000 rpm (for 1 hr) and Pt nanoparticles (2-5 nm) were collected and dried at 70° C. in air. From the TEM images, multi-shaped PT nanoparticles (2-5 nm) had multi-shapes. FIG. 19 is a FFT image of the nanoparticles. Numerous spots in the ring indicated multi-facets or various indices in Pt nanoparticles. Thus, no control on facets was observed.

In conclusion, it was demonstrated that polymer brushes were grafted on alumina nanoparticles, silicon wafers, and graphene flakes and that Pt nanoparticles were grown between the spaces created by brush-grafted system. The Pt nanoparticle growth was by physical confinement by sandwiched silicon wafer or stable suspensions of alumina and graphene oxide flakes were demonstrated as successful systems.

For the Si wafer substrate a difference between brush-coated and non-brush regions was observed concerning Pt nanoparticle growth. Hydrophilicity and hydrophobicity played a critical role in Pt nanoparticle decoration. A clear difference between grain boundaries in the brush-coated region was observed, where grain boundaries enabled uncontrolled and aggregated growth of Pt nanoparticles while brush regions resulted in uniform dispersions. PHEMA brush regions resulted in faceting of Pt nanoparticles. Au nanoparticles formed facets in the BiBB-coated region, where bromide end group of BiBB functioned as fixed ligand architecture.

Alumina nanoparticles coated with PAA and decorated with Pt nanoparticles showed <5 nm and uniformly decorating Pt nanoparticles while non-PAA grafted alumina nanoparticles were not observed to be decorated and resulted in Pt nanoparticles similar to free-solution growth method. Orderly arrangement of diffraction spots in PAA grafted system indicated greater tunability of facet for this sample as compared to non-PAA grafted alumina nanoparticles.

Alumina nanoparticles with PNIPAAm brushes showed triangular shaped nanoparticles at the edges of alumina nanoparticles. Alumina nanoparticles with PHEMA brushes showed <2 nm Pt nanoparticles growing between alumina nanoparticles, where diffraction spots showed remarkable formation of single facet system. Alumina nanoparticles with PMMA brush showed <2 nm Pt nanoparticles with Pt changing from spherical to faceted at the out ring of the coating on alumina core particles.

1. A method for producing multifaceted nanoparticles, the method comprising:
(a) obtaining a template comprising a substrate and a polymer brush having a plurality of polymers each attached by a first end to the substrate and each having a free opposing second end located opposite the first end, wherein the second end is functionalized with a functional group;
(b) contacting the polymer brush with a solution comprising a nanoparticle precursor material; and
(c) forming, from the precursor material and the functional groups located on the second end of the plurality of polymers, multifaceted nanoparticles wherein the functional groups have affinity for the facets of the multifaceted nanoparticles.

2. The method of claim 1, wherein the size and/or shape of the facets are controlled, in part, by the functional groups.

3. The method of claim 2, wherein the size and/or shape of the facets are substantially uniform.

4. The method of claim 1, wherein the multifaceted nanoparticles have a spherical shape with an average diameter of 100 nm or less.

5. The method of claim 1, wherein the multifaceted nanoparticle has a platelet shape, an elongated rod shape, hexagonal shape, octagonal shape, heptagonal shape, square shape, triangular shape, rectangular shape, trapezoid shape, and oval shape.

6. The method of claim 1, wherein the facets are 3 to 8 sided facets.

7. The method of claim 1, wherein the substrate is flexible.

8. The method of claim 1, further comprising:
obtaining a second template having a second substrate and a second polymer brush having a plurality of polymers each attached by a third end to the second substrate and each having a free opposing fourth end located opposite the third end, wherein the fourth end is functionalized with a functional group;
positioning the second ends of the polymers from the polymer brush proximate to the fourth ends of the polymers from the second polymer brush;
contacting the polymer brush and the second polymer brush with the solution; and
forming the multifaceted nanoparticles between the second and fourth ends of the plurality of polymers wherein the functional groups on the second and fourth ends of the polymers have affinity for the facets.

9. The method of claim 8, wherein the second template has substantially the same substrate, polymer brush, and/or functional groups as the template in step (a).

10. The method of claim 1, wherein the substrate is a carbon nanotube, a nanorod, a quantum dot, a hollow shell, a nanostructure, a polymer chain, a microstructure, a microtube, a microwire, a microrod, a corrugated surface, a roughened surface, a curved surface or a film, and a nanoarchitectured surface.

11. The method of claim 1, wherein the plurality of polymers include a hydrophilic polymer.

12. The method of claim 1, wherein the plurality of polymers comprises a thermoresponsive polymer.

13. The method of claim 1, wherein the functional group is an amine, phosphorous, a thiol group, an alkyl, a halide, hydrogen sulfite, phosphate, carboxylic acid, a polyol, an alkyl sulfate, or combinations thereof.

14. The method of claim 1, wherein the precursor material includes a metal salt.

15. The method of claim 14, wherein the produced multifaceted nanoparticles comprise a metal or an oxide or alloy thereof, wherein the metal is a noble metal selected from silver (Ag), palladium (Pd), platinum (Pt), gold (Au), rhodium (Rh), ruthenium (Ru), rhenium (Re), or iridium (Ir), or any combinations or oxides or alloys thereof.

16. The method of claim 15, wherein the multifaceted nanoparticles are bimetallic or trimetallic particles.

17. A multifaceted nanoparticle prepared by the method of claim 1.

18. A multifaceted nanoparticle composite material comprising:
(a) a substrate;
(b) a polymer brush having a plurality of polymers each attached by a first end to the substrate and each having a free opposing second end located opposite the first end, wherein the second end is functionalized with a functional group; and
(c) a plurality of multifaceted nanoparticles that have affinity for the functional groups of the plurality of polymers.

19. The multifaceted nanoparticle of claim 18, wherein the substrate comprises graphene oxide or alumina nanoparticles.

20. An article of manufacture comprising the multifaceted nanoparticle composite material of any one of claim 18, wherein the article of manufacture is an optical film, a plasmonic substrate, a zero Possion's ratio material, a responsive polymer material, a flexible nano-device, a catalytic architecture, a controlled release media, a separation media, a membrane, energy storage, sensor device, medicinal or chemical delivery system.
